(19) United States
(12) Patent Application Publication
(10) Pub. No.: US 2026/0192550 A1
(43) Pub. Date: Jul. 9, 2026

(54) AUTOMOTIVE LAMINATE WITH EDGE SEAL

(71) Applicant: AGP WORLDWIDE OPERATIONS GMBH, Zug (CH)

(72) Inventors: Laura GRANADOS CARO, Zwijnaarde (BE); Andres Fernando SARMIENTO SANTOS, Canton, MI (US); Gonzalo Rafael VIZCARRA MENDOZA, Lima (PE); Ricardo BRASIL, Zwijnaarde (BE); Sergio VIZCARRA, Zwijnaarde (BE); Kevin J. CANO, Lima (PE); Paolo DE ANGELIS, Pastena (IT)

(21) Appl. No.: 19/133,684

(22) PCT Filed: Nov. 28, 2023
(86) PCT No.: PCT/IB2023/061989

§ 371 Date: May 28, 2025

Related U.S. Application Data
(60) Provisional application No. 63/385,155, filed on Nov. 28, 2022.

(51) Int. Cl. B32B 17/10

(52) U.S. Cl. CPC B32B 17/10302; B32B 17/10036; B32B 17/1055; B32B 2605/00

(57) ABSTRACT

The complexity of modern automotive glazing has been increasing as the industry moves towards full autonomous vehicles and consumers demand increased levels of comfort, convenience, and safety. This is especially true of laminates where value added components can be embedded between the glass layers. However, many of the materials used in the manufacture of said laminates are sensitive to moisture. Thus, it is necessary to seal the edges of the laminate. A number of methods have been developed but all have drawbacks. The edge sealed laminate of the invention is produced by injecting the edge seal material, after the laminate has been processed in an autoclave, into a gap, left by a spacer. The resulting edge seal need only contact the interior glass surfaces.

### FIELD OF THE INVENTION

The invention relates to the field of laminated automotive glazing.

### BACKGROUND OF THE INVENTION

The vehicle glazing has long been used to mount components such as the rearview mirror, rain sensors and antennas.

With the trend towards full autonomous vehicles, as well as consumer demand for increased levels of comfort, convenience, and safety, the complexity of modern automotive glazing has been increasing at a rapid rate for a number of reasons. For one, the glazing surrounds and encloses the passenger compartment occupying a substantial portion of both the cabin interior and vehicle exterior surface area. The total glazed area of the average vehicle has also been increasing which reduces the area available to non-glazing mounted components.

Another reason is that laminated glazing lend themselves particularly well to many of these new innovative technologies as it is possible to embed components within the soft polymer interlayers of the glazing where the components are protected by the hard transparent glass layers. Thus, the glazing becomes an integral and permanent part of the new and innovative technology.

The Integration of at least some of the components required by these new technologies with the glazing has the added benefits of reducing final assembly time and how many part numbers need to be managed.

Today, many automotive laminates are produced with components that are imbedded within the laminate. These include but are not limited to performance films, solar reflecting coatings, embedded wire heating, antennas, touch sensors, head up displays (HUD), integrated photovoltaic solar cells, conductive coating-based defroster circuits, light scattering means for indirect illumination and lighting.

We shall refer to the set of components that are embedded within the laminate as inserts. An insert may be comprised of a single component or a set comprising multiple components. We can further classify inserts as passive or active. Heat reflecting solar control films are an example of a passive insert which requires no power. Active inserts are those that require an electrical connection from the insert to the exterior of the glazing. Films on which the level of light transmission can be varied electrically are an example of active inserts. Likewise, laminates containing LED lights, touch sensors, heated defroster circuits, antennas and other electrical devices are also active inserts.

One of the challenges of producing these advanced complex laminates comes from the sensitivity to moisture of many of the materials used to produce such laminates and the resulting degradation in performance that can occur from exposure to moisture. To prevent the ingress of moisture and protect the materials, an edge seal is often required.

Moisture causes degradation in a number of ways.

Water is an excellent solvent which will dissolve many substances given enough time. Over the lifetime of a typical laminate, even a small quantity can cause degradation over time.

Many substances will also react with water forming undesired compounds. This is also more likely with even very small quantities when exposed over the life of the laminate.

While pure water is non-conductive ions will tend to go into solution allowing the water to become conductive. Thus, any electric conductor needs to be isolated from any water that may be present. Many plastics are hygroscopic. While the water absorbed by the plastic may not always degrade the plastic, the plastic will tend to expand, increasing in volume and an increase in stress. The plastic may also serve as a conduit allowing the water to reach other moisture sensitive materials in the laminate. Laminates, in general, are articles comprised of multiple layers of thin, relative to their length and width, material, with each thin layer having two oppositely disposed major faces, typically of uniform thickness, which are permanently bonded to one and other across at least one major face of each layer. The layers of a laminate may alternately be described as sheets or plies. In addition, the glass layers of a glazing may be referred to as panes.

Laminated safety glass is made by bonding two layers of annealed glass together using a polymer bonding layer comprised of a thin sheet of transparent thermoplastic (bonding interlayer).

Safety glass is glass that conforms to all applicable industry and government regulatory safety requirements for the application.

Annealed glass is glass that has been slowly cooled from the bending temperature down through the glass transition range. This process relieves any stress left in the glass from the bending process. Annealed glass breaks into large shards with sharp edges. When laminated safety glass breaks, the shards of broken glass are held together, much like the pieces of a jigsaw puzzle, by the polymer layer helping to maintain the structural integrity of the glass. A vehicle with a broken windshield can still be operated. The polymer layer also helps to prevent penetration by objects striking the laminate from the exterior and in the event of a crash occupant retention is improved.

All windshields are required by law to be annealed, laminated, safety glass.

While laminated glass is only required for the windshield, it is being used in other positions increasingly.

The polymer bonding layer (bonding interlayer) component has the primary function of bonding the major faces of adjacent layers to each other. The bonding interlayer may be a solid or liquid that is subsequently cured and transformed into a solid. The material selected is typically a clear solid thermoplastic polymer. While there are numerous transparent plastics, few have the required level of adhesion to glass and can survive the extremes of temperature and UV exposure for the life of the vehicle.

For automotive use, the preferred bonding interlayer is polyvinyl butyral (PVB). In addition to being the most economical, PVB has excellent adhesion to glass and is optically clear once laminated. Automotive PVB is a highly engineered and optimized material.

One important material property of PVB is adhesion to glass. Adhesion needs to be within a certain range. If the adhesion is too high, the PVB tends to tear rather than stretch when the laminate breaks. If the adhesion is too low, the broken glass shards can break free. This is known as spalling. This is just one of the important material properties. The index of refraction is matched to soda-lime glass to prevent internal reflections and secondary images. Ultra-violet inhibitors are added to protect the vehicle occupants and interior materials. The challenge with using PVB, compared to other conventional bonding interlayers is that PVB requires lamination using heat and pressure.

While plasticized PVB is hygroscopic, in non-plasticized PVB, the absorption of moisture and swelling is minimized and not a concern for standard laminates.

A number of other types of bonding interlayer are available, generally for non-automotive applications such as in solar panels and architectural windows. These include but are not limited to, ionoplast polymers, ethylene vinyl acetate (EVA), cast in place (CIP) liquid resin and Solar control coatings, which have become fairly standard on architectural glazing, were once rarely found on passenger vehicles despite their proven ability to reduce the load on the vehicle HVAC and improve fuel efficiency. However, this is changing in response to regulatory requirements for energy efficiency as well as the industry move towards the production of more and more fully electric vehicles.

Many of these modern, multi-layer complex coatings, with a thickness measured in nano-meters, are very fragile and are also very sensitive to moisture. Special handling of the coated glass is required during fabrication to prevent damage to the coating. By applying the coating to one of the interior glass surfaces of the laminate, the coating is protected from physical damage. In addition to being physically fragile, the coating must be protected from exposure to moisture. This is typically done by masking off the glass layer that the coating is applied to such that there is no coating applied along the periphery of the laminate or by deletion of the coating along the edge. However, if an interlayer other than standard automotive PVB is used an edge seal may be needed to protect the coating.

As discussed, even if the insert itself is not sensitive to moisture, if an interlayer is used that absorbs moisture, an edge seal may be needed. As the interlayer absorbs moisture it will tend to swell which can cause increased stress levels resulting in an increased probability of glass breakage and optical distortion.

Any type of active electrical insert needs to be protected from exposure to moisture. Moisture can lead to degradation and the failure of electrical and electronic devices by reacting with the materials or by providing an unintended path for current.

These types of active inserts include but are not limited to embedded wire heating, antennas, touch sensors, active displays, solar cells, conductive coating-based defroster circuits and lighting.

Edge injected lighting is a newer technology in which the laminate, usually a roof, is used as a light guide. Light is injected along and normal to the edge of glass or along and perpendicular to the edge through one of the glazing's major surfaces by means of light bars mounted to and/or along the edge of glass. The injected light becomes trapped withing the glass layers by means of total internal reflection. The light is decoupled and emitted by light scattering means applied to any of the layers of the glazing. The light scattering means for indirect illumination might be considered a moisture sensitive material if disposed onto a performance film. In any case, this technology is likely to be combined with other different technologies such as integrated photovoltaic solar cells, antennas, touch sensers or others that are moisture sensitive. If this is the case, then in addition to all of the other criteria for the edge seal we must add the requirement that the edge seal be optically clear so as to not block the light injection.

There are a very limited number of materials that are suitable for use as an automotive glazing edge seal. In addition to being able to survive the extremes of temperature required of automotive applications, the material used as an edge seal must provide an excellent moisture barrier, have good compatibility and adhesion to the glass and other materials and components that it comes in contact with and last the life of the vehicle. Typically, a combination of materials must be used with two or more edge sealants applied increasing cost and complexity.

In addition, some of the materials that would provide a good edge seal, cannot be used because they are not capable of surviving the heat and pressure of the autoclave.

One method used to seal the edge of the glazing is encapsulation. The glazing is placed in a mold and a polymer is injected into the mold covering and sealing the edge of the glazing. This is a good solution for parts where an encapsulation is needed. Otherwise, it is not cost effective to encapsulate a part just to seal the edge. In addition, the encapsulation is not always required to capture the entire edge of glass. The bottom edge of an encapsulated windshield is often left exposed.

A less expensive alternative to encapsulation is often used in which a plastic is extruded along the edge of the glass. The main drawback here is that the extrusion must capture surface one and four of the laminate as well as the edge of glass in order to have sufficient adhesion and to provide an adequate seal. As is the case with encapsulations, the entire edge of glass may not require the extrusion. Also, the trend for the last several years has been to mount the glazing with surface one of the glazing flush with the sheet metal, with an exposed bare edge and without any trim, molding, or encapsulation.

In another method, an extruded trim is bonded to the edge of glass. The drawbacks to this method are similar to those of a trim directly extruded onto the glazing.

The edge may be sealed prior to the autoclave process. However, this limits the types of materials that may be used as many are not compatible with the heat and pressure of the autoclave. This also can lead to premature sealing of the edge of glass resulting in trapped air and a higher reject and failure rate.

It would be highly desirable to have an edge seal that did not have these drawbacks.

### BRIEF SUMMARY OF THE INVENTION

An automotive laminate with an edge seal comprising at least two glass layers, at least one interlayer, and at least one moisture sensitive material embedded within the laminate and a single material edge sealant injected into a gap along the edge of glass. The depth of the gap relative to the edge of glass is at least 3.00 mm, and preferably at least 10.00 mm.

The gap is formed by a spacer that is placed between the glass layers during assembly of the layers of the laminate prior to the autoclave process. The space is removed after autoclave processing leaving a void.

The gap is filled by means of a computer controlled automated positioning injection system. The edge seal material is first heated to lower its viscosity. A precision metering pump is used to force the heated edge seal material through an injection nozzle positioned normal to the edge of glass and moved around and along the edge of the laminate filling the gap.

The types of materials that may be used as an edge seal include but are not limited to thermoset, elastomers, and thermoplastic polymers.

Polyisobutylene (PIB) with and without desiccant fillers meets the criteria for glass adhesion and durability, is compatible with most components and interlayers, and also provides an adequate moisture resistant edge seal.

Non-plasticized PVB can also be used as an edge seal material for some inserts as it has a relatively lower rate of moisture absorption compared to for example plasticized PVB, and is already validated and optimized for automotive application.

### ADVANTAGES

Single edge seal material results in a simplified process with higher throughput.
Process lends itself well to automation.
Allows for the use of an edge seal material that would not survive the conventional automotive lamination process.
Does not require adhesion to surface one and four

### BRIEF DESCRIPTION OF THE SEVERAL VIEWS OF THE DRAWINGS

FIG. 1A shows a cross section of typical laminate.

FIG. 1B shows a cross section of typical laminate with coating on surface two and a performance film.

FIG. 2 shows an exploded isometric view of laminated roof with a peripheral edge seal.

FIG. 3 shows a top view of laminated roof with a peripheral edge seal.

FIG. 4A shows a cross section of with a laminate with peripheral gap spacer in place.

FIG. 4B shows a cross section of with a laminate with peripheral gap spacer removed.

FIG. 5A shows a cross section of with a laminate with a peripheral gap being injected with an edge seal.

FIG. 5B shows a cross section of with a laminate with a peripheral edge seal.

FIG. 6 shows the laminate with dispensing head positioned normal to the edge.

### REFERENCE NUMERALS OF DRAWINGS

2 Glass
4 Bonding/Adhesive layer (plastic Interlayer)
6 Obscuration/Black Paint
12 Infrared reflecting film
16 Edge Seal
18 Infrared reflecting coating
24 Insert
30 Spacer
32 Nozzle
34 Dispense Head
36 Gap
101 Exterior side of glass layer 1 (201), number one surface.
102 Interior side of glass layer 1 (201), number two surface.
103 Exterior side of glass layer 2 (202), number 3 surface.
104 Interior side of glass layer 2 (202), number 4 surface.
201 Outer glass layer
202 Inner glass layer

### DETAILED DESCRIPTION OF THE INVENTION

The present disclosure can be understood more readily by reference to the detailed descriptions, drawings, examples, and claims in this disclosure. However, it is to be understood that this disclosure is not limited to the specific compositions, articles, devices, and methods disclosed unless otherwise specified and as such can vary. It is also to be understood that the terminology used herein is for the purpose of describing aspects only and is not intended to be limiting.

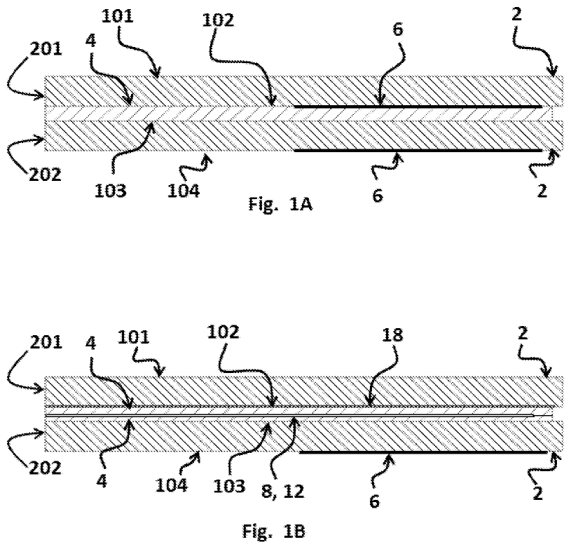

Typical automotive laminated glazing cross sections are illustrated in FIGS. 1A and 1B. The laminate is comprised of an exterior or outer glass 2 layer 201, and an interior or inner glass layer 202, that are permanently bonded together by a polymer layer 4 (interlayer). In a laminate, the glass surface that is on the exterior of the vehicle is referred to as surface one, 101, or the number one surface. The opposite face of the exterior glass layer 201 is surface two, 102, or the number two surface. The glass 2 surface that is on the interior of the vehicle is referred to as surface four, 104, or the number four surface. The opposite face of the interior layer of glass 202 is surface three, 103, or the number three surface. Surfaces two, 102, and three, 103 are bonded together by the polymer layer 4. An obscuration 6 may be also applied to the glass. Obscurations are commonly comprised of black enamel frit printed on either the number two, 102 or number four surface 104 or on both. The laminate may have a coating 18 on one or more of the surfaces. The laminate may also comprise a film 12 laminated between at least two polymer layers 4 (FIG. 1B).

The following terminology is used to describe the laminated glazing of the invention.

The term “glass” can be applied to many inorganic materials, include many that are not transparent. For this document we will only be referring to transparent glass. From a scientific standpoint, glass is defined as a state of matter comprising a non-crystalline amorphous solid that lacks the ordered molecular structure of true solids. Glasses have the mechanical rigidity of crystals with the random structure of liquids.

Glass is formed by mixing various substances together and then heating to a temperature where they melt and fully dissolve in each other, forming a miscible homogeneous fluid.

A glazing is an article comprised of at least one layer of a transparent material which serves to provide for the transmission of light and/or to provide for viewing of the side opposite the viewer and which is mounted in an opening in a building, vehicle, wall or roof or other framing member or enclosure. The types of glass that may be used include but are not limited to the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions as well as infrared reflecting and other types of coatings.

While the focus of the embodiments and discussion is on laminated roofs it can be appreciated that the invention is not limited to roofs. The invention may be implemented in any of the other glazing positions of the vehicle. In addition, the invention may be practiced with any type of glazing and is not limited to automotive.

The laminated glazing is typically comprised of two glass layers. The first glass layer has an overall length of L_{f} and an overall width of W_{f}. The second glass layer has an overall length of Lₛ and an overall width of Wₛ. It must be understood that an overall length means an average length since the glazing is not a perfect rectangle. The same consideration must be made for the overall width. The first glass layer is a curved glass layer and its dimensions are the same as the second glass layer so when they are bonded together their edges align and are flush with each other. In one embodiment, the combined dimensions of the second glass layer are different than the combined dimensions of the first glass layer. For instance, Lₛ and Wₛ could be substantially smaller than L_{f} and W_{f}.

Just about any type of material will experience some sort of a change if exposed to water under the right conditions and for sufficient duration. The phrase “moisture sensitive” shall include all materials that may experience unacceptable level of degradation at some point over the lifetime of the laminate when said laminate is placed in service as intended and exposed to moisture. As an example, while automotive PVB will absorb a small quantity of moisture, swelling is minimal and the quantity is not sufficient to result in any measurable level of degradation of the glass or any other materials, such as solar coatings, used in typical automotive laminates. Therefore, we would not describe PVB as moisture sensitive. However, it is possible that a material that is sensitive to the level of moisture found in PVB may be used in a laminate in which case an interlayer other than PVB would need to be used.

Moisture sensitive materials includes but are not limited to materials that when exposed to water undergo a chemical change, dissolve, experience a dimensional change, or experience a change in optical properties.

Moisture sensitive materials include but are not limited to coatings, interlayers, plastics, electrical conductors, and adhesives.

Moisture sensitive components are comprised of at least one moisture sensitive material. An example of a moisture sensitive component is the solar cell. As there is an electrical potential across the surfaces of the cell, any water will provide an undesired path for the flow of current.

Moisture sensitive inserts comprise at last one moisture sensitive component or moisture sensitive material.

Moisture sensitive material containing inserts may comprise a performance film. Performance films include heat reflecting solar control, stiffening, HUD combiner and various others.

Moisture sensitive material containing inserts may also include but are not limited to solar cells, LED lighting, light guides, touch sensors, and displays.

The edges of the insert are normally hidden from view from the interior or exterior of the vehicle by an obscuration typically applied to surface two 102 of the outer glass layer 201 and surface four 104 of the inner glass layer 202.

The width of the obscuration is sufficient to hide both the edge sealer, dam and the portions of the insert that are not intended to be visible. This includes any electrical connection points.

The automotive laminate with an edge seal disclosed herein is comprised of at least two glass layers, at least one interlayer, and at least one moisture sensitive material embedded within the laminate and a single material edge sealant injected into a gap along the edge of glass.

Further, the automotive laminate with an edge seal disclosed may comprise any combination of moisture sensitive and non-moisture sensitive materials, components and inserts without limit include those discussed and those not. The only limitation is that there must be at least one moisture sensitive material within the laminate.

With the typical automotive laminate, the interlayer is cut to substantially the same size as the flat glass layers. To form the gap, the interlayer of the invention is cut smaller so as to leave a gap around the periphery or edge of glass of the laminate. The width of the gap is dependent upon a number of factors including the type of edge seal, the thickness of the layers, the type of insert, the type of glass, the bonding interlayer used and the tolerance stack. The minimum depth of the gap is typically 3.00 mm. If the depth is too great, then it may become difficult to inject the edge seal fully into the cavity. The depth of the gap relative to the edge of glass is at least 3 mm, and preferably at least 10.00 mm. The gap between glass layers is advantageous since it allows de-airing of the bonding interlayer.

The void created between the glass layers to form the gap needs to be supported to prevent breakage during the autoclave process. This is accomplished by placing a spacer in the void during assembly of the layers of the laminate. A material that does not stick to glass and interlayer, which is compatible with the interlayer and that can survive the heat and pressure of the autoclave must be used.

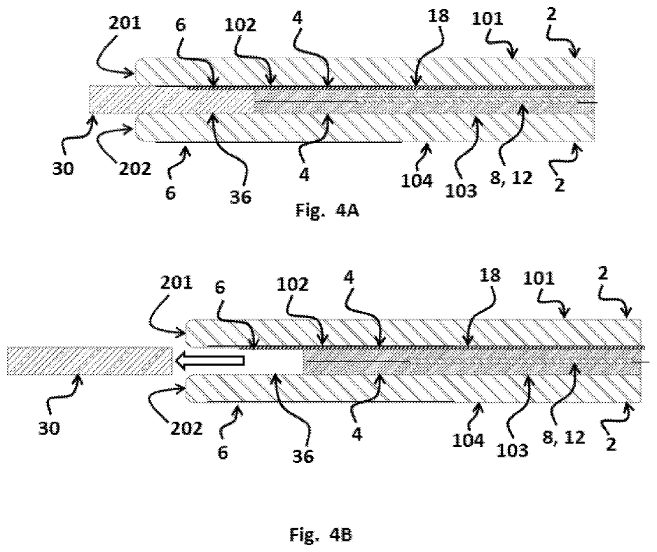

In FIG. 4A, a cross section of a laminate with a spacer in place is shown. In FIG. 4B the removal of the space is shown.

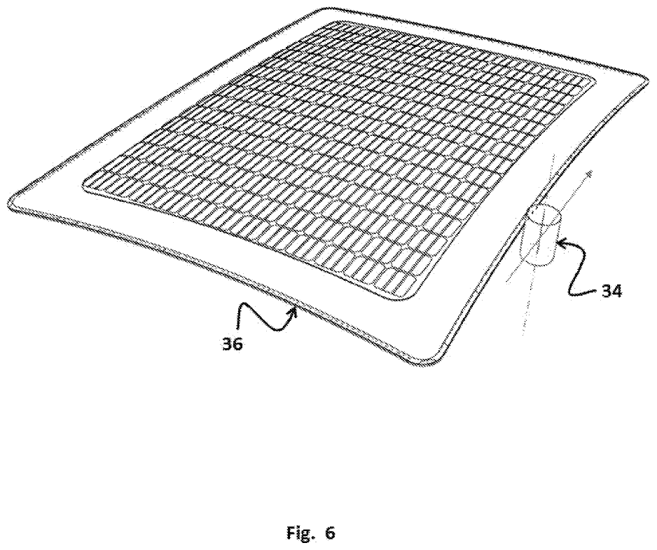

After lamination, a computer-controlled injection dispensing system is used to inject the edge seal material into the gap. It is necessary to fill the gap after lamination because the gap facilitates the air that is trapped between the interlayer and the glass layers to leave during lamination. If the gap is filled with the edge seal before lamination is completed, there is a high probability that air bubbles are generated and trapped. In the case of a thermoplastic edge seal material, the material is first heated to the temperature that will result in the desired viscosity. Heat may also be used for other types of material to lower viscosity. A precision metering pump dispenses the edge seal under control of the computer. The computer calculates a dispense rate as a function of the volume of the peripheral gap and the rate at which the dispense nozzle is moving relative to the gap. In this manner, the gap is filled without overflow. FIG. 6 shows the edge seal dispensing head as it moves around the periphery of the laminate.

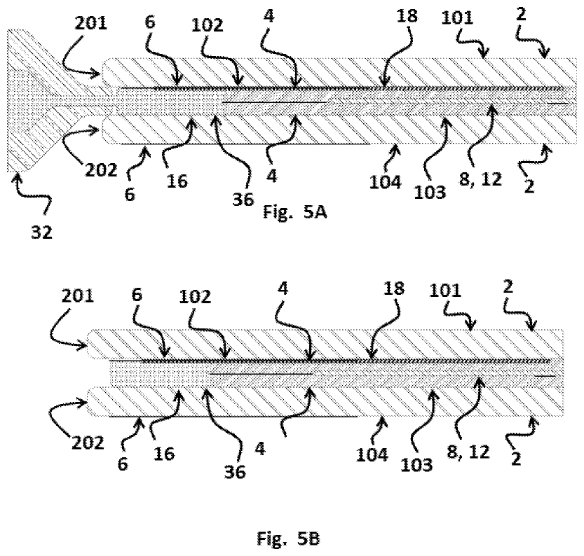

FIG. 5A shows the injection nozzle injecting the edge seal material into the gap. FIG. 5B show the edge sealed laminate.

Any number of means may be used to position the dispense head relative to the laminate. The glass may remain stationary as the dispense head moves. The dispense head may remain stationary as the laminate is moved (as is commonly done when applying primer and adhesive) or any combination may be used without departing from the concept of the invention.

The types of materials that may be used as an edge seal include but are not limited to thermoset polymers, thermoplastic polymers, and elastomers. Surprisingly, it has been found that ordinary automotive PVB, which already meets the criteria for glass adhesion and durability is compatible with most components and interlayers and also provides an adequate moisture resistant edge seal even though standard automotive grade PVB does absorb some moisture due to the plasticizer mixed in with the PVB to soften it. For applications that are highly sensitive to moisture, standard PVB cannot be used as the interlayer. Non-plasticized PVB or PIB may still be used for the edge seal. As an example, while nano-meter thick silver layers used to produce solar control glass coatings are very sensitive to moisture, the moisture content of standard PVB does not react with the silver sufficient to compromise performance or durability. However, if the coating extends to the very edge of the glazing where it is exposed to the atmosphere, the coating will rapidly corrode and degrade allowing for further ingress of water.

### EXAMPLES

### Example 1

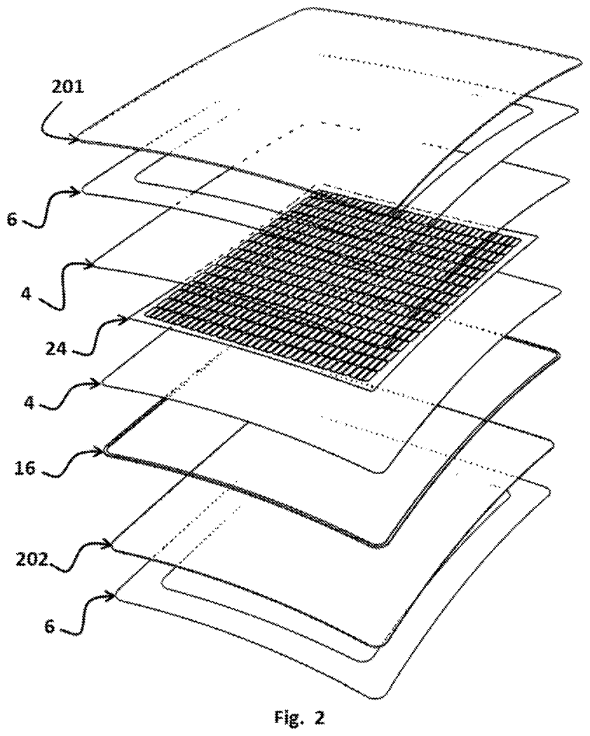

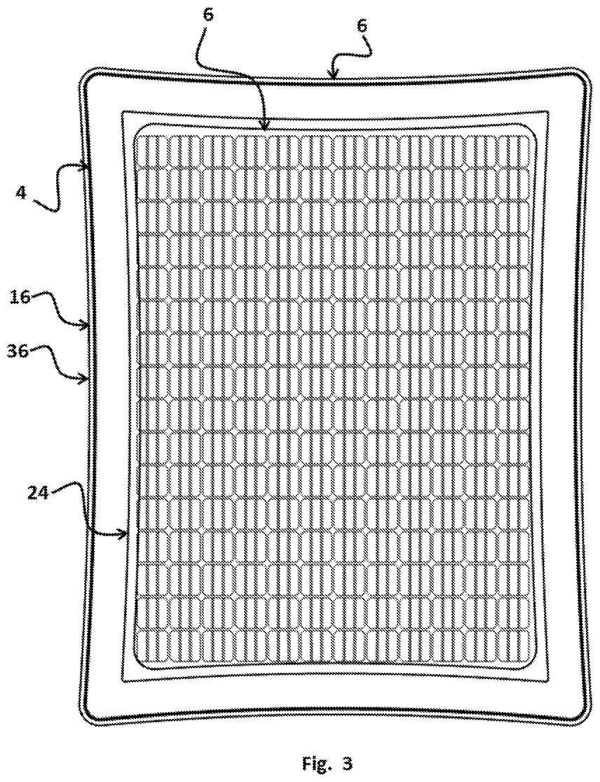

Example one is the laminated roof with edge seal aspects of which are shown in FIGS. 2, 3 and 6. The inner 202 glass layer is comprised of 2.60 mm dark solar green soda-lime glass. The outer 201 glass layer is 1.80 ultra-clear soda-lime glass. The overall dimensions of the roof are 800 mm by 1200 mm. A 100 mm wide black frit obscuration 6 is screen printed on surface two 102 and surface four 104.

The two glass layers are bent and allowed to cool. The outer glass layer 201 is place with surface one, 101 facing down and the components of the laminate are assembled. The laminate is assembled with a 1.00 mm thick photovoltaic insert 24. The photovoltaic insert comprises a plurality of photovoltaic cell strings that are interconnected sandwiched between two layers of 1.00 mm thick EVA interlayer which are in turn sandwiched between the two glass layers. Also, at least one material used to fabricate the photovoltaic insert is not compatible with PVB requiring the use of EVA. As EVA absorbs moisture and the photovoltaic insert is not compatible with moisture an edge seal is required. Therefore, the insert 24 comprises at least one component containing a material that is sensitive to and degraded by moisture.

The EVA sheets are cut such that the outer edge of the EVA is 12 mm inboard of the edge of glass. A 3 mm thick 25 mm wide strip of silicone elastomer is applied around the periphery of the EVA as a spacer 30 prior to the addition of the inner glass layer to the assembly.

The assembled laminate is then deaired and processed in an autoclave. Next, the spacer 30 is removed leaving behind a gap 36 with a depth of 12 mm between the two glass layers. The laminate is then mounting in a computer-controlled edge seal injection system. The heated viscous edge seal 16 material is metered by a precision pump and injected into the gap 36 through a dispensing head 34 and injection nozzle 32 positioned normal to the edge of glass. The dispense rate and speed are precisely controlled so as to just fill and not overfill the void.

### EMBODIMENTS

Embodiment one is the laminated glazing of example one wherein the insert is a LED lighting circuit.

Embodiment two is the laminated glazing of example one wherein the insert is a touch sensitive circuit.

Embodiment three is the laminated glazing of example one wherein the insert comprises an antenna system.

Embodiment four is the laminated glazing of example one wherein the edge seal material is PVB.

Embodiment five is the laminated glazing of example one wherein the edge seal material is PIB.

Embodiment six is the laminated of example one further comprising edge injected lighting and a third 1.00 mm EVA interlayer.

Embodiment seven is the laminated glazing of example one further comprising a LED lighting circuit and a 0.76 mm PVB interlayer.

Embodiment eight is the laminated glazing of example one further comprising a touch sensitive circuit and a third 1.00 mm EVA interlayer.

Embodiment nine is the laminated glazing of example one further comprising an antenna system and a 0.76 mm PVB interlayer.

1. A laminated glazing for a vehicle, the glazing comprising:
at least two glass layers comprising:
a first glass layer having a length L_{f}, a width W_{f}, an exterior surface oriented towards the outside of the laminated glazing, an interior surface oriented towards the inside of the laminated glazing and an edge surface; and
a second glass layer having a length Lₛ, a width Wₛ, an interior surface oriented towards the inside of the laminated glazing, an exterior surface oriented towards the outside of the laminated glazing and an edge surface;
at least one bonding interlayer having a length Lᵢ, a width Wᵢ and edges, and being in contact with the interior surface of the first glass layer and/or the second glass layer, wherein the length Lᵢ is smaller than both lengths L_{f} and Lₛ and the width Wᵢ is smaller than both widths W_{f} and Wₛ;
at least one moisture sensitive material embedded within said at least one bonding interlayer;
a gap formed between the at least two glass layers internal surfaces and extending from the edge of the first and/or second glass layers to the edge of the bonding interlayer and spanning the periphery of the glazing; and
an edge seal material filling said gap.

2. The laminated glazing of claim 1, wherein the gap has a depth that extends from the edge of the first and/or second glass layers to the edge of the bonding interlayer of at least 3 mm.

3. The laminated glazing of claim 1 wherein, the gap has a depth that extends from the edge of the first and/or second glass layers to the edge of the bonding interlayer of at least 10 mm.

4. The laminated glazing of any of the preceding claims, wherein said at least one bonding interlayer is comprised of polyvinyl butyral.

5. The laminated glazing of any of the preceding claims, wherein the edge seal is substantially flush with the edge of the glazing.

6. The laminated glazing of any one of the preceding claims, wherein the edge seal is comprised of one of the following: a thermoset polymer, a thermoplastic polymer, and an elastomer.

7. The laminated glazing of any one of the preceding claims, wherein the edge seal is comprised of one of the following dispensed polyisobutylene, and dispensed non-plasticized polyvinyl butyral.

8. The laminated glazing of any one of the preceding claims, wherein each moisture sensitive material of said at least one moisture sensitive material is selected from the following a lighting means, a touch sensor, a photovoltaic integrated cells, a heated circuit, an antenna, light scattering means for indirect illumination, an electrical conductor, electrical insulator, and a graphic.

9. The laminated glazing of any one of the preceding claims, wherein the at least one bonding interlayer comprises two bonding interlayers sandwiching the at least one moisture sensitive material comprising integrated photovoltaic cells and sealed by an edge seal comprised of polyisobutylene.

10. The laminated glazing of any of the preceding claims is a vehicle roof.

11. A vehicle comprising the laminated glazing of any of the preceding claims.
